(19) United States
(12) Patent Application Publication
(10) Pub. No.: US 2025/0101540 A1
(43) Pub. Date: Mar. 27, 2025

(54) TIN PLATE AND MANUFACTURING METHOD THEREFOR

(71) Applicants: INSTITUTE OF RESEARCH OF IRON AND STEEL, JIANGSU PROVINCE/SHA-STEEL, CO. LTD (CN), Suzhou, Jiangsu (CN); ZHANGJIAGANG YANGTZE RIVER COLD ROLLED PLATE CO., LTD., Suzhou, Jiangsu (CN); JIANGSU SHAGANG GROUP CO., LTD., Suzhou, Jiangsu (CN)

(72) Inventors: Yifeng SONG, Suzhou (CN); Haotian LAN, Suzhou (CN); Xiaohan XU, Suzhou (CN); Chongxiang YUE, Suzhou (CN)

(73) Assignees: INSTITUTE OF RESEARCH OF IRON AND STEEL, JIANGSU PROVINCE/SHA-STEEL, CO. LTD (CN), Suzhou, Jiangsu (CN); ZHANGJIAGANG YANGTZE RIVER COLD ROLLED PLATE CO., LTD., Suzhou, Jiangsu (CN); JIANGSU SHAGANG GROUP CO., LTD., Suzhou, Jiangsu (CN)

(21) Appl. No.: 18/729,743

(22) PCT Filed: Jul. 26, 2023
(86) PCT No.: PCT/CN2023/109410

§ 371 Date: Jul. 17, 2024

(30) Foreign Application Priority Data
Oct. 17, 2022 (CN) 202211264096.3

(51) Int. Cl. C21D 8/02; B22D 11/00; C21C 7/10; C21D 1/18; C21D 6/00; C21D 9/46; C22C 38/00; C22C 38/02; C22C 38/04; C22C 38/06; C25D 3/30; C25D 5/36

(52) U.S. Cl. CPC C21D 8/0278; B22D 11/001; C21C 7/10; C21D 1/18; C21D 6/005; C21D 6/008; C21D 8/0205; C21D 8/021; C21D 8/0226; C21D 8/0236; C21D 8/0263; C21D 9/46; C22C 38/001; C22C 38/002; C22C 38/02; C22C 38/04; C22C 38/06; C25D 3/30; C25D 5/36; C21D 2211/003; C21D 2211/005

(57) ABSTRACT

A manufacturing method for a tin plate including a component design of low-carbon aluminum killed steel; under the condition of not increasing the alloy content and the production control difficulty, the content of elements such as C, Mn, Al and N in the tin plate is designed, and corresponding hot rolling, cold rolling, annealing and leveling processes are used; the strengthening effects of conventional elements, carbon and manganese, are fully utilized, aluminum nitride precipitation control in hot rolling is taken into account, a proper cold rolling reduction rate is selected, the ferrite grain size and cementite precipitation in steel are controlled by means of continuous annealing and over-aging treatment, and a specific temper rolling process is used, so that a tin plate having small strength and hardness fluctuations, a high elongation rate and a short yield plateau is produced.

### CROSS-REFERENCE TO RELATED APPLICATIONS

The present application claims priority to Chinese Patent Application No. 202211264096.3, filed to the China Patent Office on Oct. 17, 2022 and entitled “TIN PLATE AND MANUFACTURING METHOD THEREFOR”, the entire content of which is incorporated herein by reference.

### TECHNICAL FIELD

The present application belongs to the technical field of alloy materials, in particular to a tin plate and a manufacturing method therefor.

### BACKGROUND

An aerosol can is a metal packaging container for containing various reagent products such as air fresheners and pesticides and composed of a top cover, a can body and a bottom cover. The top cover is the most complicated in deformation and usually formed by a tin plate having a thickness ranging from 0.30 mm to 0.45 mm through multi-pass stamping deformation machining, a requirement for a stamping formability of the tin plate is high, and a problem of wrinkling is prone to occurring during stamping when a strength (or hardness) of the tin plate is too high. Meanwhile, the top cover, after being connected with the can body and the bottom cover, needs to tolerate a pressure of a reagent filled in the can, the tin plate needs to have a certain strength (or hardness), especially, a requirement for pressure resistance of a high-pressure aerosol can is higher, and correspondingly, a strength needed for the tin plate is higher. Besides, as the top cover is an outer part and thus coated on a surface with clear lacquer so as to keep metal luster, glossiness of an appearance color of the cover also needs to be kept consistent, but the tin plate is stretched and deformed during a machining process of the top cover, and then a problem of surface darkening is prone to occurring. Therefore, a tin plate needs to be developed, which meets the requirement for stamping formability, pressure resistance and surface glossiness of the top cover of the aerosol can at the same time.

To meet the requirement for the stamping formability and the pressure resistance of the top cover of the aerosol can, the existing tin plate for the top cover of the aerosol can is designed by adopting two main types of components, including: (1) low-carbon aluminum killed steel is adopted, a batch annealing process is adopted, annealing time is long, carbon and nitrogen atoms are fully precipitated, aging resistance is good, and thus good stamping formability is obtained; (2) interstitial-free steel (IF steel) is adopted to form an interstitial-free ferritic structure, the aging resistance is good, alloy elements such as Mn, Ti and B are added, and a hardness of a steel plate is improved by solid solution strengthening and precipitation strengthening to meet the requirement for the pressure resistance. To meet the requirement for the surface glossiness of the top cover of the aerosol can, surface brightness of the cover after stamping is maintained by increasing a tinning amount in the prior art.

For example, the prior art discloses an aging-resistant tin plate, which adopts a component design of the low-carbon aluminum killed steel: C 0.02-0.06% and Al 0.005-0.040%, a batching annealing process is adopted for production, and the requirement for machining formability of the top cover can be met; but a product hardness is in a range of 55±4, the hardness is low, which may be merely used for a common low pressure can and cannot meet the requirement for the high pressure resistance of a top cover of a medium-pressure can and a high-pressure can, and as a temperature in a batching annealing steel coil is non-uniform, hardness fluctuation of a head, middle and a tail of the steel coil is large, and it is not good for production of a high-speed cover manufacturing line.

The prior art further discloses a tin plate for a top cover of an aerosol can and a production method therefor, a component design of the interstitial-free steel (IF steel) is adopted: C 0.0015-0.0030%, Mn 0.50-0.60%, Ti 0.045-0.065%, and B 0.0002-0.0006%, though the aging resistance is good, a stamping cracking ratio is low, a content of C needs to be controlled at a range from 15 ppm to 30 ppm, steel smelting production difficulty is high, more alloy elements such as Mn, Ti and B are further added, and smelting cost is high; and meanwhile, high hot rolling and annealing process temperatures are adopted, energy consumption during the process is large, an oxide-scale is prone to being thickened and is not easy to remove during the hot rolling process, and consequently, a problem of surface quality during a subsequent process is caused, and production control difficulty is high.

### SUMMARY OF THE INVENTION

Therefore, a technical problem to be solved by the present application is to overcome the above defects existing in a tin plate in the prior art, so as to provide a tin plate and a manufacturing method therefor.

Thus, the present application provides the following technical solution.

The present application provides a method for manufacturing a tin plate, including the following steps: steel making and continuous casting, hot rolling, pickling and cold rolling, continuous annealing and temper rolling, and tinplating;
wherein chemical components of a plate blank during a steel smelting and continuous casting process in mass percent are controlled to be: C 0.020-0.040%, Mn 0.15-0.25%, Si≤0.03%, P≤0.015%, S≤0.010%, Al 0.03-0.06%, N≤0.0030%, and the balance Fe and other inevitable impurities, and contents of Al and N elements in mass percent meet a relational expression Al≥0.02%+11.57N;
a heating temperature of the plate blank during a hot rolling process is controlled at a range from 1180° C. to 1220° C., an intermediate billet has a thickness ranging from 40 mm to 42 mm, a finish rolling temperature is in a range from 860° C. to 890° C., and a coiling temperature is in a range from 640° C. to 670° C.;
a temperature of strip steel in a rapid cooling zone during a continuous annealing and temper rolling process is controlled at a range from 360° C. to 380° C., a cooling rate is in a range from 100° C./s to 130° C./s, the strip steel after cooling enters an aging zone, the strip steel of a first section in the aging zone has a temperature ranging from 400° C. to 420° C., aging time is in a range from 60 s to 80 s, the strip steel of a second section in the aging zone has a temperature ranging from 320° C. to 420° C., and aging time is in a range from 120 s to 140 s; and temper rolling adopts a two-stand temper mill, a temper rolling force of the first stand temper mill is in a range from 4000 kN to 4500 kN, a temper rolling force of a second stand temper mill is in a range from 3000 kN to 3500 kN, the strip steel has a tension ranging from 40 kN to 60 kN, and an elongation of temper rolling is in a range from 1.4% to 1.6%.

Optionally, a single-side tinning amount is controlled to a range from 2.7 g/m² to 2.9 g/m² during an tinplating process, the strip steel has a speed ranging from 320 m/min to 380 m/min, a soft melting temperature is in a range from 260° C. to 263° C., and a height from a soft melting device to a water quenching tank is in a range from 4.2 m to 4.6 m.

Optionally, the steel smelting and continuous casting includes: subjecting molten steel to converter smelting and RH refining to be continuously cast into a plate blank.

Optionally, the hot rolling includes: rough rolling, finish rolling, laminar cooling and coiling to obtain a hot-rolled steel coil.

Optionally, the hot-rolled steel coil has a thickness ranging from 2.5 mm to 3.0 mm.

Optionally, the pickling and cold rolling includes: subjecting a hot-rolled steel coil to uncoiling, acid pickling, trimming, cold rolling and coiling to obtain a chilled coil;
the chilled coil has a thickness controlled to a range from 0.30 mm to 0.45 mm during the acid pickling and cold rolling process; and a cold rolling reduction rate is in a range from 85% to 88%.

Optionally, the continuous annealing and temper rolling includes: subjecting the chilled coil to uncoiling, degreasing cleaning, continuous annealing, temper rolling, trimming and coiling to obtain an annealed steel coil.

Optionally, during the continuous annealing process, a speed of the strip steel is controlled at a range from 400 m/min to 450 m/min, and a temperature of the strip steel in a soaking zone is in a range from 740° C. to 760° C.; and
the temper rolling is dry temper rolling.

Optionally, the tinplating includes: subjecting the annealed steel coil to uncoiling, degreasing cleaning, acid pickling, electroplating, soft melting, passivation, oiling and coiling to obtain an tinplated steel coil; and
the soft melting is induction soft melting. The induction soft melting has advantages that temperature rise is fast and energy consumption of an alloy layer is controlled to be low. The present application provides a tin plate, manufactured by adopting the above manufacturing method.

Optionally, the tin plate has a thickness ranging from 0.30 mm to 0.45 mm, a hardness (HR30T) is in a range of 58±2, a yield strength is in a range from 300 MPa to 350 MPa, a tensile strength is in a range from 360 MPa to 400 MPa, a percentage elongation after fracture is in a range from 33% to 38%, and a yield elongation is in a range of ≤3%. A microstructure of the tin plate is an equiaxed ferrite and cementite particles, wherein a ferrite grain size is in a range from 10 level to 11 level, and cementite is uniformly dispersed and distributed. A single-side tinning amount of the tin plate is in a range from 2.7 g/m² to 2.9 g/m², wherein an alloy tin content is in a range from 0.4 g/m² to 0.6 g/m².

A description of effects and selection of main components designed by the present application:

C: C is the most economical strengthening element in steel, and maintaining a certain content of C during the steel smelting process is beneficial for obtaining a material strength and hardness at low cost; with increase of the C content, the material hardness is increased, too high hardness and low elongation of the tin plate are prone to being caused by too high C content, the stamping formability and aging resistance of the tin plate are reduced, meanwhile, a control range of the C content affects fluctuation of the material hardness, however, too narrow control range will greatly increase the steel smelting cost. Thus, the present application selects the C content in a range of 0.02% to 0.04%.

Mn: Mn, as a solid solution strengthening element, can improve a strength of the steel plate and is not obvious in ductility decrease, meanwhile, Mn and S are combined to form MnS so as to reduce hot shortness of the steel, however, too high Mn content will increase alloy cost. Thus, the present application selects the Mn content in a range of 0.15% to 0.25%.

Si: Si is prone to enriched oxidation on a surface of the steel, which is not beneficial for surface quality and plating performance of the steel plate, so the lower the Si content, the better, and the present application selects Si≤0.03%.

P: P is high in solid solution strengthening effect but prone to segregation to form a banded structure, which reduces ductility and toughness of the steel plate and is not beneficial for formability, and the present application selects P≤0.015%.

S: for the tin plate, S belongs to harmful impurity elements, which is prone to forming sulfide inclusions and not beneficial for the formability of the steel plate, and the present application selects S≤0.010%.

N: for the tin plate, N belongs to harmful impurity elements, wherein interstitial solid solution N atom increases the strength and hardness of the steel plate, reduces ductility, and meanwhile, makes the steel plate prone to having a stretcher strain mark during stamping deformation, so the N content in the steel needs to be reduced, and the present application selects N≤0.0030%.

Al: Al, as a deoxidizing agent, is added during the steel smelting process, meanwhile, Al and N may be combined to form AlN, as N in the steel cannot be removed completely, adding a certain amount of Al may fix N in the steel, which improves the aging resistance, keeping a certain extra proportion of Al playing a role in nitrogen fixation is beneficial for fully fixing N in low-carbon steel, namely, (Al−0.02%)/27×6× (N/14), but too high Al content is prone to causing increase of inclusions in steel smelting, making castability of continuous casting poor and increase of the alloy cost. Thus, the present application selects the Al content in a range of 0.03% to 0.06%, which meets a relational expression Al≥0.02%+11.57N.

The method for manufacturing the tin plate in the present application takes into account the stamping formability, pressure resistance and production economy of the tin plate needed by the top cover of the aerosol can. In the manufacturing method of the present application, a description of important steps during each process is:
steel smelting: RH vacuum degassing treatment is adopted, the C content may be accurately controlled at a range from 0.02% to 0.04%, the hardness of the needed tin plate is obtained by fully utilizing the solid solution strengthening effect of C, the RH process may also effectively remove N, the N content in the steel is reduced, which is beneficial for the stamping formability, and meanwhile, the Al content needed for fixing N is reduced;
hot rolling: an austenite rolling process is adopted, meanwhile, relatively low heating temperature and rolling temperature of the plate blank and an appropriate thickness of an intermediate billet are controlled, and problems of high energy consumption, poor surface quality and coarse grains caused by high-temperature rolling production are avoided. If the heating temperature of the plate blank is too high, a large amount of AlN is dissolved during the heating process, resulting in increase of a content of solid solution nitrogen, AlN can be fully precipitated by a higher aluminum content and long-time high-temperature coiling, however, too low temperature makes rolling difficult and is prone to causing low finish rolling temperature, and thus, the heating temperature of the plate blank is controlled at a range from 1180° C. to 1220° C.; too small thickness of the intermediate billet causes large temperature drop during the rolling process, fails to meet the requirement for the finish rolling temperature and makes temperature uniformity of the steel coil poor, and too large thickness of the intermediate billet leads to high rolling difficulty, so the thickness of the intermediate billet is selected in a range from 40 mm to 42 mm; under the condition of ensuring that the temperature is higher than an Ar3 phase transformation point, a lower finish rolling temperature is adopted, two-phase region rolling is avoided, and the finish rolling temperature is selected in a range from 860° C. to 890° C.; and when the coiling temperature is too high, coarse grains are prone to being formed, the strength is reduced, too low temperature is not beneficial for precipitation of the solid solution N, and thus the coiling temperature is selected in a range from 640° C. to 670° C.

Cold rolling: if a reduction rate of the cold rolling is too large, a recrystallization temperature is increased, a higher annealing temperature is needed, and meanwhile, after annealing, a grain size of the steel plate is reduced, the hardness is increased, and a yield plateau is extended, which is not beneficial for uniform deformation during stamping; and if the reduction rate of the cold rolling is too small, coarse grains of the steel plate are caused, the hardness is low, a thinner raw material of hot rolling is further needed, the production cost is increased, and thus the reduction rate of the cold rolling is selected in a range from 85% to 88%.

Continuous annealing: continuous annealing is a key link for controlling structure performance of the steel plate, and the steel plate is heated to above a recrystallization temperature and is subjected to a process of recovery, recrystallization, grain growth and cementite precipitation. First, a ferrite structure with a certain grain size is obtained by matching a speed of the strip steel and a temperature of the soaking zone; meanwhile, solid solution C atoms in ferrite are oversaturated by adopting rapid cooling (100° C./s to 130° C./s) to obtain sufficient precipitation stored energy; first-zone aging adopts an over-aging process, the strip steel, after being subjected to rapid cooling, is reheated to reach an aging temperature (400° C. to 420° C.), heat preservation is performed for a period of time, and it helps a large amount of the cementite to be rapidly precipitated; and second-zone aging is inclined aging, the temperature of the strip steel is fully utilized (320° C. to 420° C.) and maintained for long heat-preservation time so as to further precipitate cementite, and unfavorable influence of an interstitial solid solution C atom on stamping formability is reduced. Thus, in combination with the components of the steel plate and hot rolling and cold rolling processes in the present application, the reasonable annealing process is used, namely: a speed of the strip steel is in a range from 400 m/min to 450 m/min, the temperature of the soaking zone is in a range from 740° C. to 760° C., the temperature of the rapid cooling zone is in a range from 360° C. to 380° C., a cooling rate is in a range from 100° C./s to 130° C./s, a temperature of the strip steel in a first section of the aging zone is in a range from 400° C. to 420° C., in which aging time is in a range from 60 s to 80 s, and a temperature of the strip steel in a second region of the aging zone is in a range from 320° C. to 420° C., in which aging time is in a range from 120 s to 140 s.

Temper rolling: effects of the temper rolling include adjusting a mechanical property of the steel plate after annealing, giving different surface structures and roughness to the strip steel and improving plate shape quality. Adopting a large rolling force and a small tension mode is beneficial for obtaining more movable dislocations and reducing the yield elongation, however, too large rolling force and too small tension are not beneficial for strip steel shape and surface structure control, and thus rolling forces of two temper mill stands are selected as 4000 kN to 4500 kN and 3000 kN to 3500 kN respectively, and a tension of the strip steel is in a range from 40 kN to 60 kN. As for the low-carbon aluminum killed steel, with increase of a temper rolling elongation, the yield strength of the steel plate is reduced and then increased, the temper rolling elongation reaches 1.2% or above, the yield plateau of the annealed steel plate with a thickness ranging from 0.30 mm to 0.45 mm may be eliminated, the yield strength reaches the minimum point, the temper rolling elongation continues to be increased to 1.4% or above, more removable dislocations may be obtained, the yield strength and hardness of the steel plate are increased properly, but too high temper rolling elongation increases hardness and reduces ductility remarkably, in this case, a load of the temper mill is increased, and thus the temper rolling elongation does not exceed 1.6%.

Soft melting: the tin plate is rapidly heated to a temperature higher than a tin melting point (232° C.) through a soft melting device, a tin layer is molten to obtain a smooth surface, meanwhile, a tin iron alloy layer is formed, and adhesion and corrosion resistance of the tin layer are improved. If a soft melting temperature is too low, soft melting of the tin layer is incomplete; and if the soft melting temperature is too high, the alloy layer is thickened and oxidation of the tin layer is considerable, so the soft melting temperature is selected in a range from 260° C. to 263° C., meanwhile, the height from the soft melting device to the water quenching tank is adjusted to a range from 4.2 m to 4.6 m, time of a soft melting reaction is controlled, so as to reduce a thickness of the tin iron alloy layer, and under the condition of keeping the tinning amount unchanged, brighter pure tin layers are maintained, so as to improve surface brightness of the tin plate after stamping and cover making and avoid the problem of darkening.

The technical solutions of the present application have the following advantages.

According to the method for manufacturing the tin plate provided by the present application, the component design of the low-carbon aluminum killed steel is adopted, under the condition of not changing the alloy content and the production control difficulty, by designing contents of elements such as C, Mn, Al and N in the tin plate, the corresponding hot rolling, cold rolling, annealing and temper rolling processes are used, the strengthening effect of the conventional elements such as carbon and manganese is fully utilized, in combination with aluminum nitride precipitation control in hot rolling and annealing, the appropriate cold rolling reduction rate is selected, the grain size of the ferrite in the steel and cementite precipitation are controlled through continuous annealing and over-aging treatment, the specific temper rolling process is used, the tin plate with small fluctuation of strength and hardness, high elongation and short yield plateau is produced, the requirement for the stamping formability and pressure resistance of the top cover of the aerosol can is met, components of the tin plate are simple, the processes are simple and convenient to implement, and the production cost is low. Specifically, the present application adopts steel smelting components and a combination design of the hot rolling, annealing and temper rolling processes, aluminum nitride and cementite precipitation is controlled, interstitial solid solution C and N atoms in the steel are reduced to the maximum degree, the yield plateau is effectively shortened, and the stamping formability is facilitated. In the present application, the relatively low rolling temperature and the appropriate thickness of the intermediate billet are controlled in the hot rolling, the problems of high energy consumption, poor surface quality and coarse grains caused by high-temperature rolling production are avoided, the product surface quality and the structure uniformity are improved, and the production cost is further reduced.

According to the method for manufacturing the tin plate in the present application, the induction soft melting is used, the soft melting temperature and the reaction time are controlled, meanwhile, the alloy tin amount is controlled reasonably, the effect of accurately controlling the alloy tin layer is achieved, the alloy tin amount of the tin plate is in a range from 0.4 g/m² to 0.6 g/m², and it is beneficial for maintaining the surface brightness after stamping deformation of the tin plate.

The tin plate provided by the present application has the hardness (HR30T) of 58±2, the yield strength ranging from 300 MPa to 350 MPa, the tensile strength ranging from 360 MPa to 400 MPa, the percentage elongation after fracture ranging from 33% to 38%, and the yield elongation in a range of ≤3%, wherein the hardness and the strength of the steel plate can meet the requirement for the pressure resistance of the top cover of the aerosol can, meanwhile, the fluctuation ranges of the hardness and the strength are small, the elongation is high, the yield plateau is short, stamping the top cover of the aerosol can without wrinkles may be achieved, meanwhile, the microstructure of the steel plate is equiaxed ferrite and cementite particles, the cementite is uniformly dispersed and distributed without strip cementite, cracking caused by inconsistent local deformation is avoided, and uniformity of machining and deformation is improved. By controlling the mechanical properties such as the hardness, the strength, the elongation and the yield elongation, and the microstructure of the tin plate, the problem that both the stamping formability and the pressure resistance of conventional low-carbon aluminum killed steel are difficult to consider is effectively solved, and the use demand of the top cover of the aerosol can is met.

### BRIEF DESCRIPTION OF THE DRAWINGS

In order to more clearly describe specific implementations of the present application or technical solutions in the prior art, the accompanying drawings needed by the description in the specific implementations or in the prior art will be briefly introduced below. Apparently, the accompanying drawings in the following description are some implementations of the present application. Those ordinarily skilled in the art may also obtain other accompanying drawings according to these accompanying drawings without making creative work.

FIG. 1 is a picture of a microstructure of a tin plate obtained in Example 1 of the present application.

FIG. 2 is a picture of a microstructure of a tin plate obtained in Comparative Example 1 of the present application.

FIG. 3 is a curve of an annealing process in an Example of the present application.

### DETAILED DESCRIPTION

The following embodiments are provided for better further understanding the present application, which are not limited to the preferable implementations and do not constitute a limitation on the content and the protection scope of the present application, and any product the same as or similar to the present application obtained by anybody under the inspiration of the present application or by combining the present application with features in the other prior art falls within the protection scope of the present application.

Where specific experiment steps or conditions are not indicated in the embodiments can be performed according to operations of conventional experiment steps or conditions described by documents in the art. Whatever reagent or instrument used with no indicated manufacturer may be a conventional reagent product obtained through market purchase.

A method for manufacturing a tin plate provided by the embodiments and the comparative embodiments in the present application includes: steel smelting and continuous casting, hot rolling, acid pickling, cold rolling, continuous annealing, temper rolling, and tinplating. The specific steps are:

1) Steel smelting and continuous casting: subjecting molten steel to converter smelting and RH refining to be continuously cast into a plate blank. See Table 1 for chemical components of the plate blank.

TABLE 1

| | | | | | | | | Whether meet |
|---|---|---|---|---|---|---|---|---|
| Number | C | Mn | Si | P | S | Al | N | Al ≥ 0.02% + 11.57N |
| Example 1 | 0.031 | 0.23 | 0.01 | 0.012 | 0.006 | 0.04 | 0.0015 | Yes |
| Example 2 | 0.035 | 0.15 | 0.01 | 0.012 | 0.009 | 0.05 | 0.0022 | Yes |
| Example 3 | 0.020 | 0.25 | 0.02 | 0.015 | 0.005 | 0.06 | 0.0030 | Yes |
| Example 4 | 0.040 | 0.18 | 0.01 | 0.010 | 0.010 | 0.05 | 0.0025 | Yes |
| Example 5 | 0.028 | 0.20 | 0.01 | 0.009 | 0.005 | 0.03 | 0.0009 | Yes |
| Comparative | 0.055 | 0.21 | 0.01 | 0.012 | 0.008 | 0.04 | 0.0051 | No |
| Example 1 | | | | | | | | |
| Comparative | 0.005 | 0.15 | 0.01 | 0.012 | 0.007 | 0.04 | 0.0012 | Yes |
| Example 2 | | | | | | | | |
| Comparative | 0.035 | 0.21 | 0.01 | 0.011 | 0.006 | 0.02 | 0.0028 | No |
| Example 3 | | | | | | | | |

2) Hot rolling: subjecting the continuously cast plate blank to heating, rough rolling, finish rolling, laminar cooling and coiling in sequence to obtain a hot-rolled steel coil with a thickness ranging from 2.5 mm to 3.0 mm. See Table 2 for specific parameters of the hot rolling process.

TABLE 2

| | Thick- | Heating | Thick- | Finish | |
|---|---|---|---|---|---|
| | ness of | temperature | ness of | rolling | Coiling |
| | hot-rolled | of plate | intermediate | temper- | temper- |
| | steel coil | blank | billet | ature | ature |
| Number | (mm) | (° C.) | (mm) | (° C.) | (° C.) |
| Example 1 | 2.5 | 1218 | 40 | 861 | 646 |
| Example 2 | 2.5 | 1206 | 40 | 875 | 655 |
| Example 3 | 2.75 | 1205 | 40 | 872 | 662 |
| Example 4 | 2.75 | 1185 | 40 | 873 | 667 |
| Example 5 | 3.0 | 1194 | 42 | 890 | 670 |
| Comparative | 2.5 | 1223 | 38 | 855 | 615 |
| Example 1 | | | | | |
| Comparative | 2.75 | 1235 | 40 | 902 | 698 |
| Example 2 | | | | | |
| Comparative | 3.0 | 1200 | 40 | 862 | 656 |
| Example 3 | | | | | |

3) Acid pickling and cold rolling: subjecting the hot-rolled steel coil to uncoiling, acid pickling, trimming, continuous cold rolling and coiling in sequence to obtain a chilled coil with a thickness ranging from 0.30 mm to 0.45 mm. See Table 3 for specific parameters of the hot rolling process.

TABLE 3

| | Thickness of chilled coil | Cold rolling reduction rate |
|---|---|---|
| Number | (mm) | (%) |
| Example 1 | 0.30 | 88% |
| Example 2 | 0.32 | 87% |
| Example 3 | 0.38 | 86% |
| Example 4 | 0.38 | 86% |
| Example 5 | 0.45 | 85% |
| Comparative | 0.30 | 88% |
| Example 1 | | |
| Comparative | 0.38 | 86% |
| Example 2 | | |
| Comparative | 0.45 | 85% |
| Example 3 | | |

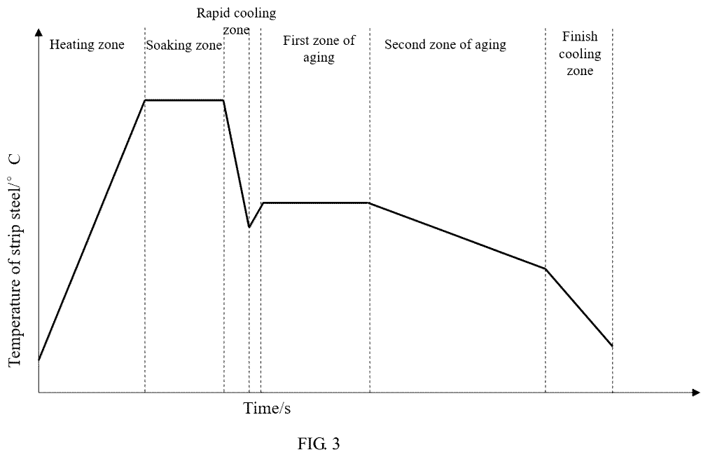

4) Continuous annealing and temper rolling: subjecting the chilled coil to uncoiling, degreasing cleaning, annealing, temper rolling, trimming and coiling in sequence to obtain an annealed steel coil. A curve of the annealing process of the Example in the present application is shown in FIG. 3. See Table 4 and Table 5 for specific process parameters.

TABLE 4

| | | | | | First | | | | |
|---|---|---|---|---|---|---|---|---|---|
| | | | Rapid | | section | | Second | | Finish |
| | | Soaking | cooling | | of aging | | section of | | cooling |
| | | zone | zone | | zone | | aging zone | | zone |
| | Temperature | Temperature | Temperature | | Temperature | | Temperature | | Temperature |
| | of strip | of strip | of strip | Cooling | of strip | Aging | of strip | Aging | of strip |
| | steel | steel | steel | rate | steel | time | steel | time | steel |
| Number | (m/min) | (° C.) | (° C.) | (° C./s) | (° C.) | (s) | (° C.) | (s) | (° C.) |
| Example 1 | 450 | 760 | 378 | 130 | 415 | 65 | 320-415 | 124 | 105 |
| Example 2 | 450 | 755 | 380 | 128 | 412 | 65 | 338-412 | 124 | 102 |
| Example 3 | 420 | 740 | 365 | 119 | 403 | 70 | 326-403 | 133 | 116 |
| Example 4 | 400 | 746 | 372 | 113 | 410 | 73 | 345-410 | 140 | 120 |
| Example 5 | 400 | 740 | 380 | 109 | 418 | 73 | 352-418 | 140 | 119 |
| Comparative | 450 | 720 | 405 | 117 | 372 | 65 | 305-372 | 124 | 110 |
| Example 1 | | | | | | | | | |
| Comparative | 420 | 780 | 408 | 129 | 370 | 70 | 305-370 | 133 | 115 |
| Example 2 | | | | | | | | | |
| Comparative | 400 | 750 | 410 | 112 | 376 | 73 | 310-376 | 140 | 119 |
| Example 3 | | | | | | | | | |

TABLE 5

| | Temper rolling | Temper rolling | | Temper |
|---|---|---|---|---|
| | force of first | force of second | Tension of | rolling |
| | stand temper | stand temper | strip steel | elongation |
| Number | mill (kN) | mill (kN) | (kN) | (%) |
| Example 1 | 4300 | 3200 | 55 | 1.5 |
| Example 2 | 4300 | 3500 | 40 | 1.4 |
| Example 3 | 4000 | 3400 | 60 | 1.5 |
| Example 4 | 4200 | 3200 | 50 | 1.5 |
| Example 5 | 4500 | 3000 | 55 | 1.6 |
| Comparative | 3500 | 3500 | 45 | 1.1 |
| Example 1 | | | | |
| Comparative | 3500 | 3000 | 40 | 1.6 |
| Example 2 | | | | |
| Comparative | 3800 | 3200 | 50 | 1.3 |
| Example 3 | | | | |

5) Tinplating: subjecting the annealed steel coil to uncoiling, degreasing cleaning, acid pickling, electroplating, soft melting, passivation, oiling and coiling to obtain an tinplated steel coil (tin plate). See Table 6 for specific process parameters.

TABLE 6

| | Speed of | Soft melting | Soft melting | Single-side |
|---|---|---|---|---|
| | strip steel | temperature | height | tinning amount |
| Number | (m/min) | (° C.) | (m) | (g/m²) |
| Example 1 | 380 | 260 | 4.6 | 2.8 |
| Example 2 | 380 | 260 | 4.6 | |
| Example 3 | 350 | 262 | 4.2 | |
| Example 4 | 350 | 262 | 4.3 | |
| Example 5 | 320 | 263 | 4.2 | |
| Comparative | 380 | 265 | 4.7 | |
| Example 1 | | | | |
| Comparative | 350 | 270 | 4.5 | |
| Example 2 | | | | |
| Comparative | 320 | 263 | 4.8 | |
| Example 3 | | | | |

### Comparative Example 4

This comparative example has a difference from Example 1 that chemical compositions of the plate blank are different, and other process operation steps and parameters are the same as those of Example 1. Specific composition of the plate blank is shown in the following table.

TABLE 7

| | | | | | | | | Whether meet |
|---|---|---|---|---|---|---|---|---|
| Number | C | Mn | Si | P | S | Al | N | Al ≥ 0.02% + 11.57N |
| Comparative | 0.046 | 0.21 | 0.01 | 0.011 | 0.008 | 0.02 | 0.0035 | No |
| Example 4 | | | | | | | | |

### Comparative Example 5

This comparative example merely has a difference from Example 1 that operation parameters of continuous annealing are different, which are shown in detail in the following table.

TABLE 8

| | | | | | First | | | | |
|---|---|---|---|---|---|---|---|---|---|
| | | | Rapid | | section | | Second | | Finish |
| | | Soaking | cooling | | of aging | | section of | | cooling |
| | | zone | zone | | zone | | aging zone | | zone |
| | Speed | Temperature | Temperature | | Temperature | | Temperature | | Temperature |
| | of strip | of strip | of strip | Cooling | of strip | Aging | of strip | Aging | of strip |
| | steel | steel | steel | rate | steel | time | steel | time | steel |
| Number | (m/min) | (° C.) | (° C.) | (° C./s) | (° C.) | (s) | (° C.) | (s) | (° C.) |
| Comparative | 450 | 760 | 378 | 130 | 378 | 65 | 310-378 | 124 | 110 |
| Example 5 | | | | | | | | | |

### Comparative Example 6

This comparative example merely has a difference from Example 1 that operation parameters of continuous hot rolling are different, which are shown in detail in the following table.

TABLE 9

| | Thick- | Heating | Thick- | Finish | |
|---|---|---|---|---|---|
| | ness of | temperature | ness of | rolling | Coiling |
| | hot-rolled | of plate | intermediate | temper- | temper- |
| | steel coil | blank | billet | ature | ature |
| Number | (mm) | (° C.) | (mm) | (° C.) | (° C.) |
| Comparative | 2.5 | 1190 | 38 | 852 | 605 |
| Example 6 | | | | | |

### Comparative Example 7

This comparative example merely has a difference from Example 1 that operation parameters of temper rolling are different, which are shown in detail in the following table.

TABLE 10

| | Temper rolling | Temper rolling | | Temper |
|---|---|---|---|---|
| | force of first | force of second | Tension of | rolling |
| | stand temper | stand temper | strip steel | elongation |
| Number | mill (kN) | mill (kN) | (kN) | (%) |
| Comparative | 3500 | 3500 | 45 | 1.1 |
| Example 7 | | | | |

Test of mechanical properties, structure and tinning amount is performed on the tinplated steel coil obtained according to the above examples and comparative examples, a specific test method refers to GB/T 2520-2017 Cold-rolled Tinplated Steel Plate and Steel Strip and GB/T 4335-2013 Test Method for Low-carbon Steel Cold-rolled Sheet Ferrite Grain Size. Test performing results are shown in Table 11.

TABLE 11

| | | | | Percentage | | | | |
|---|---|---|---|---|---|---|---|---|
| | | | | elongation | | | Single-side | Amount |
| | | Yield | Tensile | after | Yield | Grain | tinning | of alloy |
| | Hardness | strength | strength | fracture | elongation | size | amount | tin |
| Number | (HR30T) | (MPa) | (MPa) | (%) | (%) | (Level) | (g/m²) | (g/m²) |
| Example 1 | 59.1 | 331 | 384 | 34.5 | 2.8 | 11 | 2.85 | 0.52 |
| Example 2 | 58.2 | 316 | 373 | 36.5 | 2.1 | 10.5 | 2.81 | 0.54 |
| Example 3 | 58.8 | 315 | 376 | 35 | 2.0 | 10.5 | 2.78 | 0.47 |
| Example 4 | 57.9 | 320 | 382 | 35.5 | 2.2 | 11 | 2.88 | 0.51 |
| Example 5 | 57.6 | 307 | 362 | 37.5 | 1.5 | 10 | 2.85 | 0.55 |
| Comparative | 60.5 | 365 | 414 | 28.5 | 7.2 | 11.5 | 2.80 | 0.72 |
| Example 1 | | | | | | | | |
| Comparative | 56.4 | 229 | 346 | 39 | 0 | 9 | 2.82 | 0.85 |
| Example 2 | | | | | | | | |
| Comparative | 59.1 | 341 | 391 | 31.1 | 5.3 | 11 | 2.77 | 0.65 |
| Example 3 | | | | | | | | |
| Comparative | 60.1 | 344 | 408 | 29.8 | 6.5 | 11.5 | 2.85 | 0.52 |
| Example 4 | | | | | | | | |
| Comparative | 60.3 | 348 | 391 | 31.5 | 5.5 | 11.5 | 2.85 | 0.52 |
| Example 5 | | | | | | | | |
| Comparative | 61.2 | 378 | 405 | .27.0 | 8.0 | 11.5 | 2.85 | 0.52 |
| Example 6 | | | | | | | | |
| Comparative | 58.8 | 326 | 381 | 35.0 | 4.4 | 11 | 2.85 | 0.52 |
| Example 7 | | | | | | | | |

The tinplated steel coil provided by the examples and the comparative examples in the present application is applied to a production line of a top cover of an aerosol can. The cover formability, pressure resistance test and cover appearance test results are shown in Table 12. A test method for a pressure resistance value is performed with reference to GB/T 13042-2008 Packaging Container Iron Aerosol Tank.

According to the embodiment in the present application, the cover formability is good, there are no cracking and wrinkles, the pressure resistance value reaches 1.8 MPa or above, the requirement of a high-pressure aerosol product may be met, and meanwhile, the appearance of the cover is bright. Pressure resistance values of Comparative Example 1 and Comparative Example 3 are qualified, but there is a problem of cracking and wrinkles in cover forming, Comparative Example 2 is good in formability but insufficient in pressure resistance and thus cannot be used for the high-pressure aerosol can, and meanwhile, Comparative Examples 1 to 3 also have a problem of surface darkening after cover making. Comparative Examples 4 to 7 are qualified in pressure resistance values but have the problem of cracking or wrinkles in cover forming.

TABLE 12

| | | Pressure | |
|---|---|---|---|
| | | resistance | |
| Number | Cover formability | value (MPa) | Appearance |
| Example 1 | No cracking and no | 1.87 | Bright surface |
| | wrinkles | | |
| Example 2 | No cracking and no | 1.92 | Bright surface |
| | wrinkles | | |
| Example 3 | No cracking and no | 2.05 | Bright surface |
| | wrinkles | | |
| Example 4 | No cracking and no | 2.11 | Bright surface |
| | wrinkles | | |
| Example 5 | No cracking and no | 2.01 | Bright surface |
| | wrinkles | | |
| Comparative | Cracking and | 1.95 | Dark surface |
| Example 1 | obvious wrinkles | | |
| | occur | | |
| Comparative | No cracking and no | 1.71 | Dark surface |
| Example 2 | wrinkles | | |
| Comparative | No racking but | 2.16 | Dark surface |
| Example 3 | obvious wrinkles | | |
| | occur | | |
| Comparative | Cracking and | 1.92 | Bright surface |
| Example 4 | obvious wrinkles | | |
| | occur | | |
| Comparative | No racking but | 1.95 | Bright surface |
| Example 5 | obvious wrinkles | | |
| | occur | | |
| Comparative | Cracking and | 2.01 | Bright surface |
| Example 6 | obvious wrinkles | | |
| | occur | | |
| Comparative | No cracking but | 1.83 | Bright surface |
| Example 7 | having wrinkles | | |
| Product requirement | No cracking and no | ≥1.8 | Bright surface |
| of a top cover of an | wrinkles | | |
| aerosol can | | | |

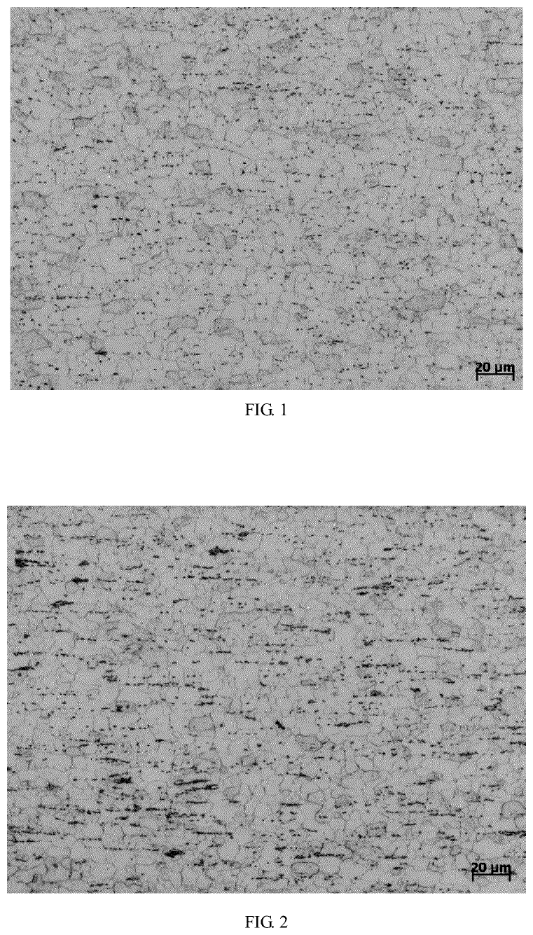

FIG. 1 is a picture of a microstructure of a tin plate provided by Example 1 in the present application. It may be seen from the figure that the microstructure is equiaxed ferrite and cementite particles, ferrite grains are equiaxed and uniform in size and are level 11 in grain size, cementite is uniformly dispersed and distributed and small in amount, and the whole structure is uniform. FIG. 2 is a picture of a microstructure of a tin plate provided by Comparative Example 1 in the present application. It may be seen from the figure that the microstructure is equiaxed ferrite and cementite particles, ferrite grains are small and are level 11.5 in grain size, cementite is large in size and large in amount, is in a strip shape or cluster shape and is non-uniform in distribution, the whole structure is non-uniform, non-uniform deformation is prone to occurring, and wrinkles or cracking of cover making are/is caused.

Apparently, the above embodiments are merely for clearly describing the examples but not for limiting the implementations. Those ordinarily skilled in the art can also make modifications or variations in other different forms based on the above description. All implementations do not need to be and cannot be exhaustively cited here. Apparent modifications or variations derived from this still fall within the protection scope of the present disclosure.

1. A method for manufacturing a tin plate, comprising the following steps: steel smelting and continuous casting, hot rolling, acid pickling and cold rolling, continuous annealing and temper rolling, and tinplating;
wherein chemical components of a plate blank during a steel smelting and continuous casting process in mass percent are controlled to be: C 0.020-0.040%, Mn 0.15-0.25%, Si≤0.03%, P≤0.015%, S≤0.010%, Al 0.03˜0.06%, N≤0.0030%, and the balance Fe and other inevitable impurities, and contents of Al and N elements in mass percent meet a relational expression Al≥0.02%+11.57N;
a heating temperature of the plate blank during a hot rolling process is controlled at a range from 1180° C. to 1220° C., an intermediate billet has thickness ranging from 40 mm to 42 mm, a finish rolling temperature is in a range from 860° C. to 890° C., and a coiling temperature is in a range from 640° C. to 670° C.;
a speed of strip steel is controlled at a range from 400 m/min to 450 m/min during the continuous annealing and temper rolling process, strip steel of a soaking zone has a temperature ranging from 740° C. to 760° C.; strip steel of a rapid cooling zone has a temperature ranging from 360° C. to 380° C., a cooling rate is in a range from 100° C./s to 130° C./s, the strip steel after cooling enters an aging zone, the strip steel of a first section in the aging zone has temperature ranging from 400° C. to 420° C., aging time is in a range from 60 s to 80 s, the strip steel of a second section in the aging zone has a temperature ranging from 320° C. to 420° C., and aging time is in a range from 120 s to 140 s; and temper rolling adopts a two stand temper mill, a temper rolling force of the first stand temper mill is in a range from 4000 kN to 4500 kN, a temper rolling force of the second stand temper mill is in a range from 3000 kN to 3500 kN, the strip steel has a tension ranging from 40 kN to 60 kN, and an elongation of temper rolling is in a range from 1.4% to 1.6%.

2. The method for manufacturing the tin plate according to claim 1, wherein a single-side tinning amount is controlled to a range from 2.7 g/m² to 2.9 g/m² during a tinplating process, the strip steel has a speed ranging from 320 m/min to 380 m/min, a soft melting temperature is in a range from 260° C. to 263° C., and a height from a soft melting device to a water quenching tank is in a range from 4.2 m to 4.6 m.

3. The method for manufacturing the tin plate according to claim 1, wherein the steel smelting and continuous casting comprises: subjecting molten steel to converter smelting and RH refining to be continuously cast into a plate blank.

4. The method for manufacturing the tin plate according to claim 1, wherein the hot rolling comprises: rough rolling, finish rolling, laminar cooling and coiling to obtain a hot-rolled steel coil.

5. The method for manufacturing the tin plate according to claim 4, wherein the hot-rolled steel coil has a thickness ranging from 2.5 mm to 3.0 mm.

6. The method for manufacturing the tin plate according to claim 1, wherein the acid pickling and cold rolling comprises: subjecting a hot-rolled steel coil to uncoiling, acid pickling, trimming, cold rolling and coiling to obtain a chilled coil;
the chilled coil has a thickness controlled to a range from 0.30 mm to 0.45 mm during the acid pickling and cold rolling process; and a cold rolling reduction rate is in a range from 85% to 88%.

7. The method for manufacturing the tin plate according to claim 1, wherein the continuous annealing and temper rolling comprises: subjecting a chilled coil to uncoiling, degreasing cleaning, continuous annealing, temper rolling, trimming and coiling to obtain an annealed steel coil.

8. The method for manufacturing the tin plate according to claim 7, wherein the temper rolling is dry temper rolling.

9. The method for manufacturing the tin plate according to claim 1, wherein the tinplating comprises: subjecting an annealed steel coil to uncoiling, degreasing cleaning, acid pickling, electroplating, soft melting, passivation, oiling and coiling to obtain a tinplated steel coil; and
the soft melting is induction soft melting.

10. The method for manufacturing the tin plate according to claim 1, wherein the tin plate has a thickness ranging from 0.30 mm to 0.45 mm, a hardness HR30T is in a range of 58±2, a yield strength is in a range from 300 MPa to 350 MPa, a tensile strength is in a range from 360 MPa to 400 MPa, a percentage elongation after fracture is in a range from 33% to 38%, and a yield elongation is in a range of ≤3%, and a microstructure of the tin plate is an equiaxed ferrite and cementite particles, wherein a ferrite grain size is in a range from 10 level to 11 level, and cementite is uniformly dispersed and distributed.

11. A tin plate, manufactured by adopting the method according to claim 1.

12. The method for manufacturing the tin plate according to claim 2, wherein the steel smelting and continuous casting comprises: subjecting molten steel to converter smelting and RH refining to be continuously cast into a plate blank.

13. The method for manufacturing the tin plate according to claim 2, wherein the hot rolling comprises: rough rolling, finish rolling, laminar cooling and coiling to obtain a hot-rolled steel coil.

14. The method for manufacturing the tin plate according to claim 2, wherein the acid pickling and cold rolling comprises: subjecting a hot-rolled steel coil to uncoiling, acid pickling, trimming, cold rolling and coiling to obtain a chilled coil;
the chilled coil has a thickness controlled to a range from 0.30 mm to 0.45 mm during the acid pickling and cold rolling process; and a cold rolling reduction rate is in a range from 85% to 88%.

15. The method for manufacturing the tin plate according to claim 2, wherein the continuous annealing and temper rolling comprises: subjecting a chilled coil to uncoiling, degreasing cleaning, continuous annealing, temper rolling, trimming and coiling to obtain an annealed steel coil.

16. The method for manufacturing the tin plate according to claim 2, wherein the tinplating comprises: subjecting an annealed steel coil to uncoiling, degreasing cleaning, acid pickling, electroplating, soft melting, passivation, oiling and coiling to obtain a tinplated steel coil; and
the soft melting is induction soft melting.

17. The method for manufacturing the tin plate according to claim 2, wherein the tin plate has a thickness ranging from 0.30 mm to 0.45 mm, a hardness HR30T is in a range of 58±2, a yield strength is in a range from 300 MPa to 350 MPa, a tensile strength is in a range from 360 MPa to 400 MPa, a percentage elongation after fracture is in a range from 33% to 38%, and a yield elongation is in a range of ≤3%, and a microstructure of the tin plate is an equiaxed ferrite and cementite particles, wherein a ferrite grain size is in a range from 10 level to 11 level, and cementite is uniformly dispersed and distributed.

18. The method for manufacturing the tin plate according to claim 3, wherein the tin plate has a thickness ranging from 0.30 mm to 0.45 mm, a hardness HR30T is in a range of 58±2, a yield strength is in a range from 300 MPa to 350 MPa, a tensile strength is in a range from 360 MPa to 400 MPa, a percentage elongation after fracture is in a range from 33% to 38%, and a yield elongation is in a range of ≤3%, and a microstructure of the tin plate is an equiaxed ferrite and cementite particles, wherein a ferrite grain size is in a range from 10 level to 11 level, and cementite is uniformly dispersed and distributed.

19. The method for manufacturing the tin plate according to claim 4, wherein the tin plate has a thickness ranging from 0.30 mm to 0.45 mm, a hardness HR30T is in a range of 58±2, a yield strength is in a range from 300 MPa to 350 MPa, a tensile strength is in a range from 360 MPa to 400 MPa, a percentage elongation after fracture is in a range from 33% to 38%, and a yield elongation is in a range of ≤3%, and a microstructure of the tin plate is an equiaxed ferrite and cementite particles, wherein a ferrite grain size is in a range from 10 level to 11 level, and cementite is uniformly dispersed and distributed.

20. The method for manufacturing the tin plate according to claim 5, wherein the tin plate has a thickness ranging from 0.30 mm to 0.45 mm, a hardness HR30T is in a range of 58±2, a yield strength is in a range from 300 MPa to 350 MPa, a tensile strength is in a range from 360 MPa to 400 MPa, a percentage elongation after fracture is in a range from 33% to 38%, and a yield elongation is in a range of ≤3%, and a microstructure of the tin plate is an equiaxed ferrite and cementite particles, wherein a ferrite grain size is in a range from 10 level to 11 level, and cementite is uniformly dispersed and distributed.
